(19) United States
(12) Patent Application Publication
(10) Pub. No.: US 2024/0282202 A1
(43) Pub. Date: Aug. 22, 2024

(54) METHOD FOR PROVIDING AN AIRCRAFT FLIGHT PLAN

(71) Applicant: Airbus Operations SAS, TOULOUSE (FR)

(72) Inventors: Alexandre BUISSON, TOULOUSE (FR); Gilles PARISOT, TOULOUSE (FR); Daniel HUYNH, TOULOUSE (FR)

(21) Appl. No.: 18/443,700

(22) Filed: Feb. 16, 2024

(30) Foreign Application Priority Data
Feb. 20, 2023 (FR) 2301541

(51) Int. Cl. G08G 5/00

(52) U.S. Cl. CPC G08G 5/0034; G08G 5/0004

(57) ABSTRACT

A method for establishing a flight plan for an aircraft by: determining a correction factor F1 related to a degradation in performance of the aircraft; using, to establish the flight plan, a model of the aircraft that incorporates a lower heating value of a reference fuel; obtaining a correction factor F2 related to a difference in lower heating value between the reference fuel and a fuel intended to be used to follow the flight plan; modifying the correction factor F1 by adding the correction factor F2; and determining the flight plan using the model of the aircraft, to which the modified correction factor F1 is given at input. It is thus possible to use an aircraft model in which the lower heating value is fixed internally.

### CROSS-REFERENCES TO RELATED APPLICATIONS

This application claims the benefit of French Patent Application Number 2301541 filed on Feb. 20, 2023, the entire disclosure of which is incorporated herein by way of reference.

### FIELD OF THE INVENTION

The present invention relates to the provision of a flight plan for an aircraft, the flight plan taking into account a correction factor related to the lower heating value of a fuel intended to be used by the aircraft to follow the flight plan.

### BACKGROUND OF THE INVENTION

One parameter that is taken into account to establish and/or analyze a flight plan is the fuel lower heating value, in order to make it possible to determine what distance a particular aircraft will be able to travel using a quantity of fuel on board.

Flight planning tools exist in order to be able to determine this distance, and these tools use aircraft models that take, at input, a correction factor related to a degradation in performance of the aircraft over their lives. These tools also use a default fuel lower heating value (FLHV), specific to regulatory properties of Jet A-1 fuel, which is the fuel currently used for the vast majority of flights.

In flight planning tools, the fuel lower heating value is fixed so as to correspond to the regulatory properties of Jet A-1 fuel, and cannot be modified without reprogramming said tools.

Thus, as illustrated schematically in FIG. 1, a known method for establishing one or more flight plans for an aircraft comprises:
a step 102 of obtaining first values of parameters of the aircraft that are representative of a reference performance of the aircraft;
a step 104 of obtaining second values of said parameters of the aircraft resulting from measurements carried out during at least one flight of the aircraft;
a step 106 of determining a correction factor F1 related to a degradation in performance of the aircraft, by comparing said second values with said first values;
a step 110 of using a model of the aircraft that incorporates a lower heating value of a reference fuel;
a step 112 of determining at least one flight plan, for at least one respective future flight, using the model of the aircraft, to which the correction factor F1 is given at input; and
a step 114 of providing said at least one flight plan.

The model of the aircraft is based on the reference performance of the aircraft, typically the performance of the aircraft upon its entry into service (EIS), to which the lower heating value of the reference fuel, on the one hand, and the correction factor F1 related to the degradation in performance of the aircraft over time, on the other hand, are applied. A flight plan is thus provided in a manner adapted to the actual performance of the aircraft using the Jet A-1 reference fuel.

However, new fuels are emerging, for example sustainable aviation fuels (SAF), and these new fuels may have a non-negligible variation in their lower heating value, that is to say a variation much greater than the Jet A-1 reference fuel.

It is then necessary to consider updating all aircraft models of flight planning tools in order to allow the fuel lower heating value to be an input datum for these models, and therefore no longer a fixed internal parameter.

However, deploying such an update is tedious, and the flight planning tools could lose accuracy in the time this deployment is carried out. It is therefore desirable to provide a solution that makes it possible to take into account the variability of the lower heating value of these new fuels in aviation, without having to modify the aircraft models on which said flight planning tools are based.

### SUMMARY OF THE INVENTION

What is thus proposed here is a method for establishing a flight plan for an aircraft, the method being executed by a computerized system, the method comprising: obtaining first values of parameters of the aircraft that are representative of a reference performance of the aircraft; obtaining second values of said parameters of the aircraft resulting from measurements carried out during at least one flight of the aircraft; determining a correction factor F1 related to a degradation in performance of the aircraft, by comparing said second values with said first values; using, to establish the flight plan, a model of the aircraft that incorporates a lower heating value of a reference fuel. The method also comprises: obtaining a correction factor F2 related to a difference in lower heating value between the reference fuel and a fuel intended to be used by the aircraft to follow the flight plan; modifying the correction factor F1 by adding the correction factor F2; and determining the flight plan using the model of the aircraft, to which the modified correction factor F1 is given at input.

Thus, by using a correction factor F1 related to a degradation in performance of the aircraft that is adjusted by way of a correction factor F2 related to said difference in lower heating value at input of the aircraft model, it is possible to use such an aircraft model in which the lower heating value is internally fixed. In addition, to take into account a non-negligible variability in fuel lower heating value, it is not necessary to redevelop and redeploy the aircraft model in pre-existing flight planning tools.

According to one particular embodiment, the correction factors F1 and F2 are fuel consumption correction factors.

According to one particular embodiment, the method furthermore comprises: transmitting the flight plan to an electronic flight display system intended to be used during a flight of the aircraft following the flight plan, the flight plan being accompanied by the modified correction factor F1.

Also proposed here is a computer program that is able to be stored on a medium and/or downloaded from a communication network in order to be read by a processor. This computer program comprises instructions for implementing the abovementioned method in any one of its embodiments when said program is executed by the processor. Also proposed here is a non-transient information storage medium storing such a computer program.

According to one particular embodiment, the method furthermore comprises the following step performed by the electronic flight display system: transmitting the modified correction factor F1 to avionics of the aircraft for performing the flight in question, in order to configure a flight management system of the avionics.

According to one particular embodiment, the method furthermore comprises the following step performed by the avionics: transmitting, once the flight has been performed, a report containing information from measurements carried out during said flight with respect to said parameters. In addition, the method furthermore comprises the following step performed by the computerized system: storing said measurement information together with the modified correction factor F1 or the correction factor F2 in a database, in order to determine the correction factor F1 for at least one subsequent flight of the aircraft.

Also proposed here is a computerized system comprising electronic circuitry configured to establish a flight plan for an aircraft and configured to: obtain first values of parameters of the aircraft that are representative of a reference performance of the aircraft; obtain second values of said parameters of the aircraft resulting from measurements carried out during at least one flight of the aircraft; determine a correction factor F1 related to a degradation in performance of the aircraft, by comparing said second values with said first values; use, to establish the flight plan, a model of the aircraft that incorporates a lower heating value of a reference fuel. The electronic circuitry is also configured to: obtain a correction factor F2 related to a difference in lower heating value between the reference fuel and a fuel intended to be used by the aircraft to follow the flight plan; modify the correction factor F1 by adding the correction factor F2; and determine the flight plan using the model of the aircraft, to which the modified correction factor F1 is given at input.

According to one embodiment, the correction factors F1 and F2 are fuel consumption correction factors.

According to one embodiment, the electronic circuitry is also configured to transmit the flight plan to an electronic flight display system intended to be used during a flight of the aircraft following the flight plan, the flight plan being accompanied by the modified correction factor F1.

According to one embodiment, the electronic circuitry is also configured to store information from measurements, received from avionics of an aircraft, carried out during said flight with respect to said parameters and accompanied by the modified correction factor F1 or the correction factor F2, in a database, in order to determine the correction factor F1 for at least one subsequent flight of the aircraft.

### BRIEF DESCRIPTION OF THE DRAWINGS

The abovementioned features of the invention, along with others, will become more clearly apparent upon reading the following description of at least one exemplary embodiment, said description being given with reference to the attached drawings, in which:

FIG. 1 schematically illustrates an algorithm for providing a flight plan for an aircraft, known from the prior art;

FIG. 2 schematically illustrates an algorithm for providing a flight plan for an aircraft, in one particular embodiment of the present invention;

FIG. 3 schematically illustrates a data path between various entities involved in establishing a flight plan and sharing this flight plan;

FIG. 4 schematically illustrates an arrangement for using an aircraft model in the context of establishing a flight plan;

FIG. 5 schematically illustrates one example of a hardware platform for implementation, in the form of electronic circuitry; and

FIG. 6 schematically illustrates an aircraft.

### DETAILED DESCRIPTION OF THE PREFERRED EMBODIMENTS

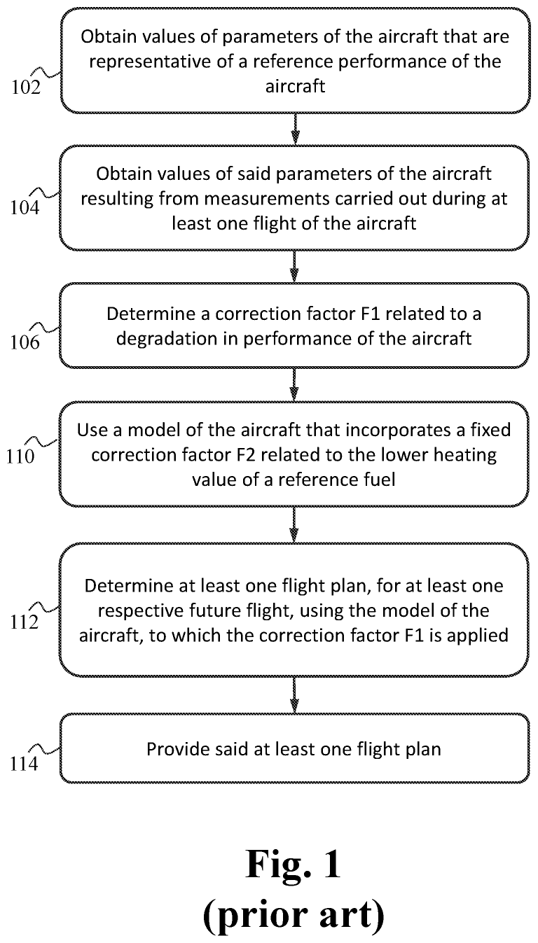

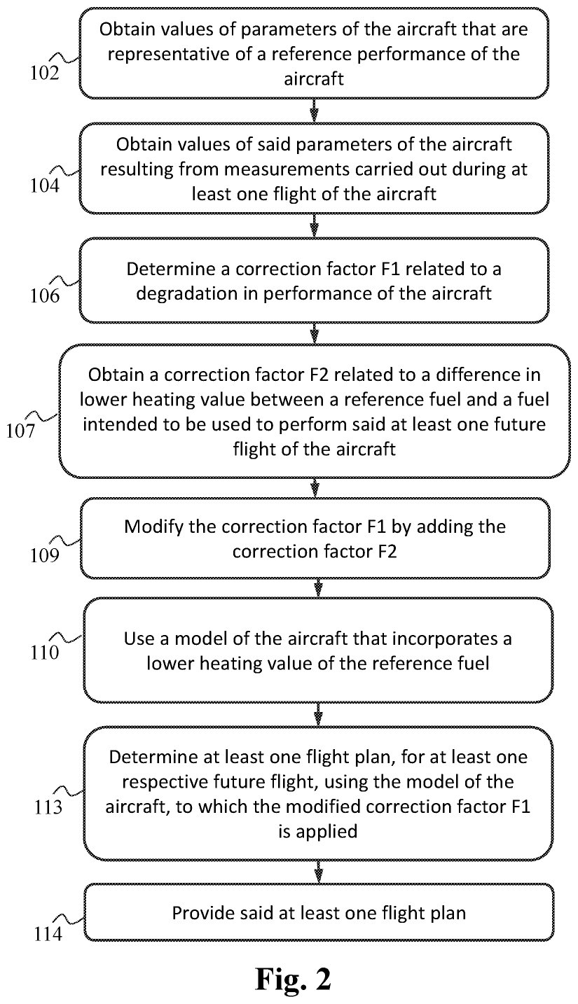

FIG. 2 thus schematically illustrates an algorithm for providing a flight plan for an aircraft, in one particular embodiment of the present invention. The algorithm in FIG. 2 makes modifications compared to the algorithm in FIG. 1 already presented above.

The algorithm in FIG. 2 is executed by a system comprising electronic circuitry, such as a computer system.

Steps 102, 104 and 106 are taken from the algorithm in FIG. 1 and are therefore not described in more detail here.

The algorithm in FIG. 2 comprises a step 107 of obtaining a correction factor F2 related to a difference in lower heating value between a reference fuel and a fuel intended to be used to perform at least one future flight of the aircraft. The reference fuel is a fuel with average characteristics of the Jet A-1 fuels used in aviation.

The reference fuel is the fuel whose lower heating value is fixed in a model of the aircraft that is used, in step 110, to establish the flight plan.

Step 107 may be performed before step 106, or in parallel with step 106.

Following steps 106 and 107, the algorithm in FIG. 2 comprises a step 109 of modifying the correction factor F1 by adding the correction factor F2.

In one preferred embodiment, the correction factors F1 and F2 are fuel consumption correction factors. In this context, it should be noted that the correction factor F2 has a signed value, and therefore that the correction factor F1 is also modified.

For example, it is established that, due to engine ageing, the performance of the aircraft has dropped by 3% compared to its entry into service. The correction factor F1 would therefore be equal to 3%, corresponding to an excess fuel consumption of 3%, for example. The correction factor F1 may also be expressed in the form of a fuel consumption coefficient, which is then equal to 1.03 (where a value equal to 1 is equivalent to a consumption of the aircraft when it leaves the factory). If, in this example, it is also established that the lower heating value of the fuel intended to be used for said at least one future flight of the aircraft involves an excess fuel consumption of 1% compared to the reference fuel, then the correction factor F2 would be equal to 1%, which would give a modified correction factor F1 of 4% at the end of step 109; whereas, if the lower heating value of the fuel intended to be used for said at least one future flight of the aircraft involves a 1% improvement in fuel consumption compared to the reference fuel (a higher lower heating value results in an increase in the distance travelled per unit of fuel), then the correction factor F2 would therefore be equal to −1%, which would give a modified correction factor F1 of 2% at the end of step 109.

This correction factor F1 modified in step 109 is then used at input in step 110. By adjusting the correction factor F1 related to the degradation in performance of the aircraft so as to take into account the difference in lower heating value between the reference fuel and the fuel intended to be used to perform at least one future flight of the aircraft, it is possible to establish an accurate flight plan using an aircraft model in which the lower heating value of the (reference) fuel is internally fixed.

Next, a step 113 (which is a modified version of step 112 of the algorithm in FIG. 1) is performed, step 113 being a step of determining at least one flight plan, for said at least one respective future flight, using the model of the aircraft in question, to which the modified correction factor F1 is given at input, that is to say with the correction factor F2 being taken into account, and not the correction factor F1 simply resulting from step 106.

Next, step 114 is performed.

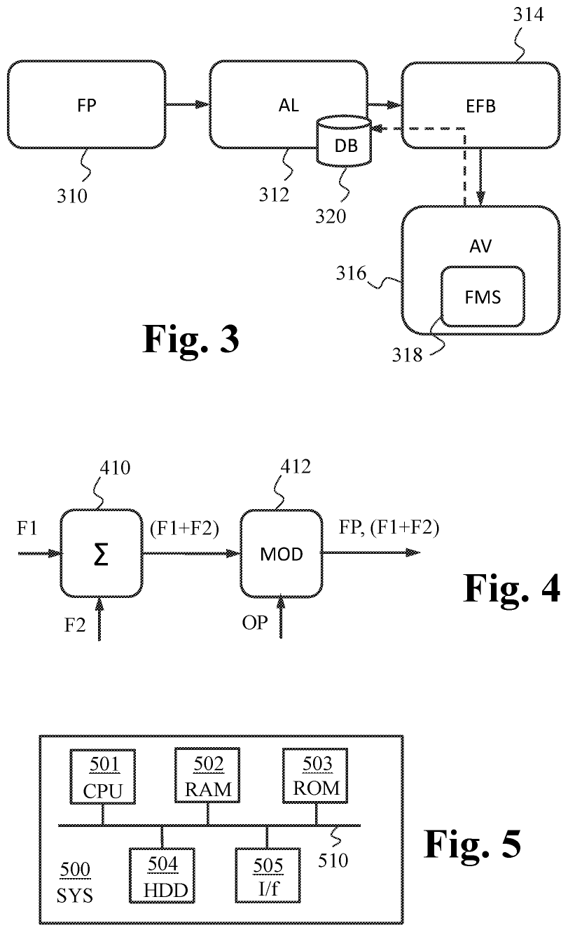

FIG. 3 schematically illustrates a data path between various entities involved in establishing a flight plan and sharing this flight plan.

A computerized system 310 of a fuel provider FP transmits information, relating to the provided fuel lower heating value, to a computerized system 312 of an airline AL. For example, the information in question is the provided fuel lower heating value, thereby allowing the computerized system 312 of the airline AL to deduce therefrom the correction factor F2 according to the lower heating value of the reference fuel (for example average lower heating value of Jet A-1). In another example, the information in question is the correction factor F2 directly. This correction factor F2 is therefore predefined, or deduced from predefined information, depending on the type of fuel provided, and is not estimated or computed individually for each aircraft flight (this would lengthen the time to model the flight plan and would require specific sensors and/or specific computing means for each aircraft).

The computerized system 312 of the airline AL comprises a database DB 320. The database DB 320 is used to store measurements carried out during flights of aircraft belonging to the airline AL. These measurements correspond to parameters that make it possible to estimate the performance of the aircraft during the flights in question (second values in the algorithm in FIGS. 1 and 2). By comparison with reference values (first values in the algorithm in FIGS. 1 and 2), the computerized system 312 of the airline AL is able to determine the correction factor F1 applicable for a particular aircraft.

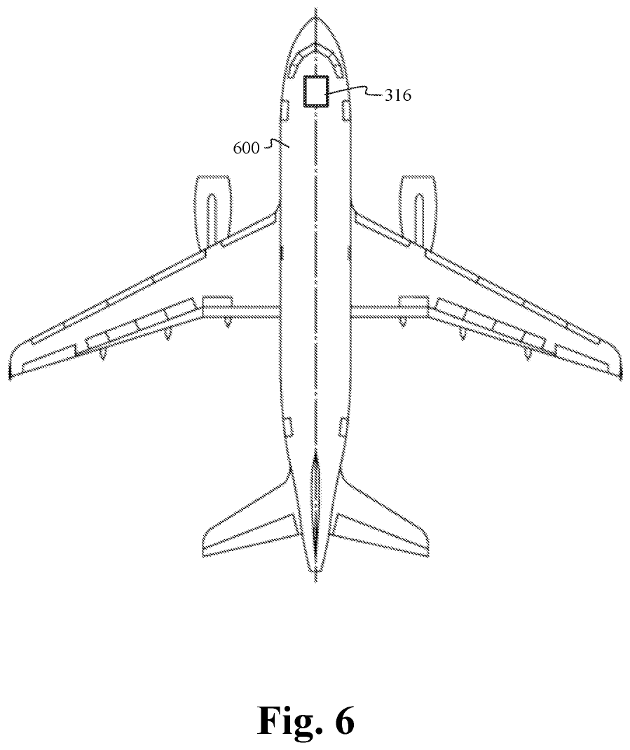

The computerized system 312 of the airline AL establishes the flight plan, in accordance with the method described with reference to FIG. 2, and transmits information relating to the flight plan to a portable electronic device available to the pilot, such as an electronic flight display system, commonly known as an EFB (electronic flight bag) 314. These electronic flight display systems EFB generally take the form of touch-sensitive electronic tablet computers and typically contain flight mission data, along with applications to operate or update them during the flight. The electronic flight display system EFB 314 serves as an intermediary between the computerized system 312 of the airline AL and avionics AV 316 of the aircraft. The avionics 316 are also illustrated schematically in FIG. 6, which shows a plan view of an aircraft 600.

Thus, by way of wired communications (for example USB (universal serial bus) communications) or wireless communications (for example Bluetooth, Wi-Fi, 4G or 5G communications), or any other type of communication, in particular secure communication, it is possible for the computerized system 312 of the airline AL to transmit the information relating to the flight plan to the electronic flight display system EFB 314. Next, by way of wired communications (for example USB communications) or wireless communications (for example Bluetooth or Wi-Fi communications), or any other type of communication (in particular secure communication), it is possible for the electronic flight display system EFB 314 to transmit the information relating to the flight plan to the avionics AV 316. The information relating to the flight plan includes the modified correction factor F1, that is to say the sum of the correction factors F1 and F2. A flight management system FMS 318 may thus be programmed taking into account the real lower heating value of the fuel used for the flight.

As a variant, it is possible for the information relating to the flight plan, including the modified correction factor F1, to be input by the pilot via a human-machine interface of the avionics AV 316.

Once the flight has been performed, information from measurements carried out during the flight with respect to parameters of the aircraft and useful for determining the performance of the aircraft, and thereby any degradation in performance of the aircraft, may be transmitted from the avionics AV 316 to the computerized system 312 of the airline AL, again using for example the electronic flight display system 314 as an intermediary. For example, the measurement information is grouped into a report (called “Cruise Report No. 2”) generated by an aircraft condition monitoring system ACMS of the avionics 316, and transmitted to the computerized system 312 of the airline AL in order to enrich the measurements stored in the database DB 320 in order to determine the correction factor F1 for at least one subsequent flight of the aircraft. In this particular embodiment, the modified correction factor F1 accompanies the measurement information in question in the database DB 320. This makes it possible, by also storing the (unmodified) correction factor F1, to ascertain the impact of the lower heating value of the fuel, and to carry out accurate post-flight performance analysis, taking into account the actual properties of the fuel used so as not to bias an estimate of any degradation in performance of the aircraft. As a variant, the correction factor F2 accompanies the measurement information in question in the database DB 320.

FIG. 4 schematically illustrates an arrangement for using an aircraft model MOD 412 as part of establishing a flight plan. In the context of FIG. 3, the arrangement in question is included in the computerized system 312 of the airline AL.

The correction factors F1 and F2 are injected at input of an adder E 410, which delivers the modified correction factor F1 at output (thus corresponding to the sum of the correction factors F1 and F2). The modified correction factor F1 is injected at input of the aircraft model MOD 412, along with other parameters OP useful for establishing the flight plan. The aircraft model MOD 412 integrates, in fixed form, the lower heating value of the reference fuel.

The aircraft model MOD 412 delivers flight plan information FP at output, along with the modified correction factor F1 (which, in the context of FIG. 3, makes it possible to configure the flight management system FMS 318 in accordance with the fuel actually used for the flight).

FIG. 5 schematically illustrates one example of a hardware platform for implementing, in the form of electronic circuitry, the computerized system 312 of the airline AL.

The hardware platform then comprises the following, connected by a communication bus 410: a processor or CPU (central processing unit) 501; a random access memory (RAM) 502; a read-only memory 503, for example a ROM (read-only memory) or an EEPROM (electrically erasable programmable ROM) or a Flash memory; a storage unit, such as an HDD (hard disk drive) 504, or a storage medium reader, such as an SD (Secure Digital) card reader; and an interface manager I/f 505.

The interface manager I/f 505 allows the computerized system 312 of the airline AL to interact with one or more devices or other computerized systems, more particularly the computerized system 310 of the fuel provider FP and the electronic flight display system EFB 314.

The processor 501 is capable of executing instructions loaded into the random access memory 502 from the read-only memory 503, from an external memory, from a storage medium (such as an SD card), or from a communication network. When the hardware platform is powered on, the processor 501 is capable of reading instructions from the random access memory 502 and executing them. These instructions form a computer program that causes the processor 501 to implement all or some of the steps and operations described here.

All or some of the steps and operations described here may thus be implemented in software form by executing a set of instructions by way of a programmable machine, for example a DSP processor (digital signal processor) or a microcontroller, or be implemented in hardware form by a dedicated machine or a dedicated electronic component (chip) or a dedicated set of electronic components (chipset), for example an FPGA (field-programmable gate array) component or an ASIC (application-specific integrated circuit) component. Generally speaking, the computerized system 312 of the airline AL comprises electronic circuitry designed and configured to implement the operations and steps described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for establishing a flight plan for an aircraft, the method being executed by a processor of a computerized system, the method comprising:
obtaining first values of parameters of an aircraft representative of a reference performance of the aircraft;
obtaining second values of said parameters of the aircraft resulting from measurements carried out during at least one flight of the aircraft;
determining a correction factor F1 related to a degradation in performance of the aircraft, by comparing said second values with said first values;
obtaining a correction factor F2 related to a difference in lower heating value between a reference fuel and a fuel to be used by the aircraft;
modifying the correction factor F1 by adding the correction factor F2 to provide a modified correction factor F1; and
determining a flight plan using a model of the aircraft, to which the modified correction factor F1 is given at input.

2. The method according to claim 1, wherein the correction factors F1 and F2 are fuel consumption correction factors.

3. The method according to claim 1, further comprising:
transmitting the flight plan to an electronic flight display system used during a flight of the aircraft following the flight plan, the flight plan being accompanied by the modified correction factor F1.

4. The method according to claim 3, further comprising:
transmitting, from the electronic flight display system, the modified correction factor F1 to avionics of the aircraft for performing the flight in order to configure a flight management system of the avionics.

5. The method according to claim 4, further comprising:
once the flight has been performed, transmitting, from the avionics, a report containing information from measurements carried out during the flight with respect to said parameters;
storing, in the computerized system, said information from measurements together with the modified correction factor F1, the correction factor F2, or both in a database, in order to determine a correction factor for at least one subsequent flight of the aircraft.

6. A non-transitory computer readable medium storing a computer program comprising instructions for implementing the method according to claim 1, when the instructions are executed by the processor of the computerized system.

7. A computerized system comprising:
electronic circuitry configured to establish a flight plan for an aircraft and configured to:
obtain first values of parameters of the aircraft that are representative of a reference performance of the aircraft;
obtain second values of said parameters of the aircraft resulting from measurements carried out during at least one flight of the aircraft;
determine a correction factor F1 related to a degradation in performance of the aircraft, by comparing said second values with said first values;
obtain a correction factor F2 related to a difference in lower heating value between a reference fuel and a fuel intended used by the aircraft;
modify the correction factor F1 by adding the correction factor F2 to provide a modified correction factor F1; and
determine a flight plan using a model of the aircraft, to which the modified correction factor F1 is given at input.

8. The computerized system according to claim 7, wherein the correction factors F1 and F2 are fuel consumption correction factors, and wherein the electronic circuitry is further configured to:
transmit the flight plan to an electronic flight display system used during a flight of the aircraft following the flight plan, the flight plan being accompanied by the modified correction factor F1.

9. The computerized system according to claim 8, further comprising electronic circuitry configured to:
store information from measurements, received from avionics of the aircraft, carried out during said flight with respect to said parameters and accompanied by the modified correction factor F1, or the correction factor F2, or both, in a database, in order to determine a correction factor for at least one subsequent flight of the aircraft.
